(19) United States
(12) Patent Application Publication
(10) Pub. No.: US 2026/0158697 A1
(43) Pub. Date: Jun. 11, 2026

(54) PRINT-THEN-CUT CALIBRATION FOR A CUTTING MACHINE

(71) Applicant: Cricut, Inc., South Jordan, UT (US)

(72) Inventors: Jackson Dean, Millcreek, UT (US); Ellen Rasmussen, Woods Cross, UT (US); Kaushik Tilve, Salt Lake City, UT (US); Veeraraghavulu Devi Veerabhadram, West Jordan, UT (US); Gregory Alan Weaver, South Jordan, UT (US); Jeremy Burton Crystal, Springville, UT (US)

(73) Assignee: Cricut, Inc., South Jordan, UT (US)

(21) Appl. No.: 19/179,661

(22) Filed: Apr. 15, 2025

Related U.S. Application Data
(60) Provisional application No. 63/634,837, filed on Apr. 16, 2024.

(51) Int. Cl. B26F 1/38; B26D 5/00

(52) U.S. Cl. CPC B26F 1/3813; B26D 5/007

(57) ABSTRACT

A method includes operating a tool of a cutting machine to form a shape at a material surface. The shape has an x-fiducial at an estimated x-coordinate at the material surface and a y-fiducial at an estimated y-coordinate at the material surface. With the shape weeded from the material surface, the method includes operating a sensor of the cutting machine to capture sensor data representative of the material surface. Based on the captured sensor data, the method includes determining a measured x-coordinate of the x-fiducial at the material surface and a measured y-coordinate of the y-fiducial at the material surface. Based on a comparison of the estimated x-coordinate and the measured x-coordinate of the x-fiducial and a comparison of the estimated y-coordinate and the measured y-coordinate of the y-fiducial, the method includes determining an x-offset and a y-offset between the tool and the sensor of the cutting machine.

### CROSS REFERENCE TO RELATED APPLICATION

This application claims priority under 35 U.S.C. § 119(e) to U.S. Provisional Application No. 63/634,837, filed on Apr. 16, 2024. The disclosure of this prior application is considered part of the disclosure of this application and is hereby incorporated herein by reference in its entirety.

### TECHNICAL FIELD

This disclosure relates to calibration of a cutting machine, and more particularly to print-then-cut calibration of a cutting machine.

### BACKGROUND

Cutting machines, which may perform electronic cutting, laser cutting, milling, embossing, stitching, heat-pressing, printing, drawing, and/or three-dimensional printing on a material, typically undergo a calibration process to properly align a cutting tool of the machine with the work material. Typically, these calibration processes require a user to provide an input related to an offset between a target design and a cut made by the machine. Accordingly, known calibration processes require the user to provide a measurement or judgment call as to the precision of the cut relative to the target design, resulting in a lengthier and often repetitive calibration process, and/or an in-exact or variable calibration outcome.

### SUMMARY

One aspect of the disclosure provides a computer-implemented method that when executed on data processing hardware causes the data processing hardware to perform operations. The operations include operating a tool of a cutting machine to form a shape at a material surface. The shape has an x-fiducial at an estimated x-coordinate at the material surface and a y-fiducial at an estimated y-coordinate at the material surface. The operations include prompting a user to weed the shape from the material surface. With the shape weeded from the material surface, the operations include operating a sensor of the cutting machine to capture sensor data representative of the material surface. Based on the captured sensor data, the operations include determining a measured x-coordinate of the x-fiducial at the material surface and a measured y-coordinate of the y-fiducial at the material surface. Based on a comparison of the estimated x-coordinate and the measured x-coordinate of the x-fiducial and a comparison of the estimated y-coordinate and the measured y-coordinate of the y-fiducial, the operations include determining an x-offset and a y-offset between the tool and the sensor of the cutting machine.

Implementations of the disclosure may include one or more of the following optional features. In some implementations, operating the tool of the cutting machine to form the shape at the material surface is responsive to receiving a user input initiating a calibration sequence. In further implementations, the operations further include prompting the user to initiate the calibration sequence.

In some examples, before operating the tool of the cutting machine to form the shape at the material surface, the operations further include prompting the user to removably attach the material surface to a support mat and to load the support mat with the material surface attached thereto at the cutting machine. In further examples, prompting the user to weed the shape from the material surface includes prompting the user to weed the shape without removing the material surface from the support mat and without unloading the support mat from the cutting machine.

In some aspects, operating the sensor of the cutting machine is responsive to a user input to resume a calibration sequence.

In some implementations, the shape includes a continuous shape at the material surface having both the x-fiducial and the y-fiducial.

In some examples, the shape includes a first shape having the x-fiducial and a second shape having the y-fiducial. The second shape is remote from the first shape at the material surface.

In some aspects, the material surface includes a sheet of paper.

Another aspect of the disclosure provides a computer-implemented method that when executed on data processing hardware causes the data processing hardware to perform operations. The operations include operating a sensor of a cutting machine to capture a first set of sensor data representative of a material surface. The material surface has a printed shape. The printed shape has a printed x-fiducial and a printed y-fiducial.

Based on the first set of sensor data, the operations include determining a printed x-coordinate of the printed x-fiducial at the material surface and a printed y-coordinate of the printed y-fiducial at the material surface. The operations include operating a tool of the cutting machine to form a cut shape at the material surface. The cut shape has a cut x-fiducial and a cut y-fiducial. The operations include prompting a user to weed the cut shape from the material surface. With the cut shape weeded from the material surface, the operations include operating the sensor of the cutting machine to capture a second set of sensor data representative of the material surface. Based on the second set of sensor data, the operations include determining a measured x-coordinate of the cut x-fiducial at the material surface and a measured y-coordinate of the cut y-fiducial at the material surface. Based on a comparison of the measured x-coordinate of the cut x-fiducial and the printed x-coordinate of the printed x-fiducial and a comparison of the measured y-coordinate of the cut y-fiducial and the printed y-coordinate of the printed y-fiducial, the operations include determining an x-offset and a y-offset between the tool and the sensor of the cutting machine. This aspect may include one or more of the following optional features.

In some implementations, the cut shape is formed at the material surface within a boundary of the printed shape.

In some examples, the operations further include prompting the user to initiate a calibration sequence. In further examples, the operations further include, responsive to the user initiating the calibration sequence, prompting the user to load the material surface at the cutting machine.

In some aspects, the printed x-fiducial includes a first printed x-fiducial having a first printed x-coordinate at the material surface and a second printed x-fiducial having a second printed x-coordinate at the material surface. The second printed x-coordinate is spaced from the first printed x-coordinate at the material surface. In these aspects, the cut x-fiducial includes a first cut x-fiducial having a first measured x-coordinate at the material surface and a second cut x-fiducial having a second measured x-coordinate at the material surface. The second measured x-coordinate is spaced from the first measured x-coordinate at the material surface. In these aspects, determining the x-offset between the tool and the sensor of the cutting machine is based on a comparison of the first measured x-coordinate of the first cut x-fiducial and the first printed x-coordinate of the first printed x-fiducial and a comparison of the second measured x-coordinate of the second cut x-fiducial and the second printed x-coordinate of the second printed x-fiducial. In further aspects, operating the tool of the cutting machine to form the cut shape at the material surface includes attempting to form the cut shape so that a distance at the material surface between the first measured x-coordinate of the first cut x-fiducial and the first printed x-coordinate of the first printed x-fiducial is equal to a distance at the material surface between the second measured x-coordinate of the second cut x-fiducial and the second printed x-coordinate of the second printed x-fiducial.

In some implementations, the printed y-fiducial includes a first printed y-fiducial having a first printed y-coordinate at the material surface and a second printed y-fiducial having a second printed y-coordinate at the material surface. The second printed y-coordinate is spaced from the first printed y-coordinate at the material surface. In these implementations, the cut y-fiducial includes a first cut y-fiducial having a first measured y-coordinate at the material surface and a second cut y-fiducial having a second measured y-coordinate at the material surface. The second measured y-coordinate is spaced from the first measured y-coordinate at the material surface. In these implementations, determining the y-offset between the tool and the sensor of the cutting machine is based on a comparison of the first measured y-coordinate of the first cut y-fiducial and the first printed y-coordinate of the first printed y-fiducial and a comparison of the second measured y-coordinate of the second cut y-fiducial and the second printed y-coordinate of the second printed x-fiducial. In further implementations, operating the tool of the cutting machine to form the cut shape at the material surface includes attempting to form the cut shape so that a distance at the material surface between the first measured y-coordinate of the first cut y-fiducial and the first printed y-coordinate of the first printed y-fiducial is equal to a distance at the material surface between the second measured y-coordinate of the second cut y-fiducial and the second printed y-coordinate of the second printed y-fiducial.

In some examples, the cut shape is weeded from the material surface without removing the material surface from the cutting machine.

In some aspects, operating the sensor of the cutting machine to capture the second set of sensor data is responsive to a user input to resume a calibration sequence.

In some implementations, the material surface includes a sheet of paper.

Yet another aspect of the disclosure provides a computer-implemented method that when executed on data processing hardware causes the data processing hardware to perform operations. The operations include operating a sensor of a cutting machine to capture a first set of sensor data representative of a material surface. The material surface has a printed shape, and the printed shape has an outer x-fiducial, an outer y-fiducial, an inner x-fiducial, and an inner y-fiducial. Based on the first set of sensor data, the operations include determining a printed x-coordinate of the outer x-fiducial at the material surface and a printed y-coordinate of the outer y-fiducial at the material surface. The operations include operating a tool of the cutting machine to form a first cut x-line at the material surface. The first cut x-line has a first cut x-coordinate. Based on a comparison of the first cut x-coordinate of the first cut x-line and the printed x-coordinate of the outer x-fiducial, the operations include determining an x-offset between the tool and the sensor of the cutting machine. The operations include operating the tool of the cutting machine to form a first cut y-line at the material surface. The first cut y-line has a first cut y-coordinate. Based on a comparison of the first cut y-coordinate of the first cut y-line and the printed y-coordinate of the outer y-fiducial, the operations include determining a y-offset between the tool and the sensor of the cutting machine. The operations include operating the sensor of the cutting machine to capture a second set of sensor data representative of the material surface. Based on the second set of sensor data, the operations include determining a printed x-coordinate of the inner x-fiducial at the material surface and a printed y-coordinate of the inner y-fiducial at the material surface. Based on the determined x-offset and the determined y-offset, the operations include operating the tool of the cutting machine to form a second cut x-line and a second cut y-line at the material surface. The second cut x-line has a second cut x-coordinate and the second cut y-line has a second cut y-coordinate. Based on a comparison of the second cut x-coordinate of the second cut x-line and the printed x-coordinate of the inner x-fiducial and a comparison of the second cut y-coordinate of the second cut y-line and the printed y-coordinate of the inner y-fiducial, the operations include adjusting the x-offset and the y-offset between the tool and the sensor of the cutting machine. This aspect may include one or more of the following optional features.

In some implementations, operating the tool of the cutting machine to form the first cut x-line includes attempting to form the first cut x-line at a midpoint of the outer x-fiducial. In further implementations, the printed x-coordinate of the outer x-fiducial includes the midpoint of the outer x-fiducial.

In some examples, operating the tool of the cutting machine to form the first cut y-line includes attempting to form the first cut y-line at a midpoint of the outer y-fiducial. In further examples, the printed y-coordinate of the outer y-fiducial includes the midpoint of the outer y-fiducial.

In some aspects, operating the tool of the cutting machine to form the first cut x-line and operating the tool of the cutting machine to form the first cut y-line are both performed before determining the x-offset and determining the y-offset between the tool and the sensor of the cutting machine.

In some implementations, operating the tool of the cutting machine to form the first cut x-line and determining the x-offset between the tool and the sensor of the cutting machine are both performed before operating the tool of the cutting machine to form the first cut y-line and determining the y-offset between the tool and the sensor of the cutting machine. In alternative implementations, operating the tool of the cutting machine to form the first cut y-line and determining the y-offset between the tool and the sensor of the cutting machine are both performed before operating the tool of the cutting machine to form the first cut x-line and determining the x-offset between the tool and the sensor of the cutting machine.

In some examples, operating the tool of the cutting machine to form the second cut x-line and the second cut y-line includes attempting to form the second cut x-line at a midpoint of the inner x-fiducial and the second cut y-line at a midpoint of the inner y-fiducial. In further examples, the printed x-coordinate of the inner x-fiducial includes the midpoint of the inner x-fiducial and the printed y-coordinate of the inner y-fiducial includes the midpoint of the inner y-fiducial.

In some aspects, the operations further include capturing a third set of sensor data representative of the material surface. The third set of sensor data includes image data captured by a camera. In these aspects, based on the third set of sensor data, the operations further include determining the first cut x-coordinate of the first cut x-line and the first cut y-coordinate of the first cut y-line. In further aspects, the operations further include capturing a fourth set of sensor data representative of the material surface. The fourth set of sensor data includes image data captured by the camera. In these further aspects, based on the fourth set of sensor data, the operations further include determining the second cut x-coordinate of the second cut x-line and the second cut y-coordinate of the second cut y-line.

In some implementations, the operations further include adjusting the x-offset and the y-offset between the tool and the sensor of the cutting machine based on historical data.

In some examples, the adjusted x-offset and the adjusted y-offset between the tool and the sensor of the cutting machine are accurate within 0.04 millimeters or less.

In some aspects, the material surface includes a sheet of paper.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a graphic preparation environment, in accordance with various implementations;

FIG. 2 is a sectional view of a cutting machine;

FIG. 3 is a schematic view of a work material surface during an example calibration technique;

FIG. 4 is a schematic view of a work material surface during another example calibration technique;

FIGS. 5A-5D are schematic views of a work material surface during yet another example calibration technique;

FIG. 6 is schematic view of an example computing device that may be used to implement the systems and methods described in this document.

FIG. 7 provides a flowchart of an exemplary arrangement of operations for a method of calibrating a tool and a sensor of a cutting machine.

FIG. 8 provides a flowchart of an exemplary arrangement of operations for a method of calibrating a tool and a sensor of a cutting machine.

FIGS. 9A and 9B provide a flowchart of an exemplary arrangement of operations for a method of calibrating a tool and a sensor of a cutting machine.

Like reference symbols in the various drawings indicate like elements.

### DETAILED DESCRIPTION

The detailed description of exemplary implementations herein makes reference to the accompanying drawings, which show exemplary implementations by way of illustration. While these exemplary implementations are described in sufficient detail to enable those skilled in the art to practice the disclosure, it should be understood that other implementations may be realized and that logical changes and adaptations in design and construction may be made in accordance with this disclosure and the teachings herein without departing from the spirit and scope of the disclosure. Thus, the detailed description herein is presented for purposes of illustration only and not of limitation.

As used herein, the terms “including,” “comprising,” “having,” and variations thereof mean “including but not limited to” unless expressly specified otherwise.

Accordingly, the terms “including,” “comprising,” “having,” and variations thereof are intended to cover a non-exclusive inclusion, such that a process, method, article, or apparatus that comprises a list of elements does not include only those elements but may include other elements not expressly listed or inherent to such process, method, article, or apparatus. An enumerated listing of items does not imply that any or all of the items are mutually exclusive and/or mutually inclusive, unless expressly specified otherwise.

Further, in the detailed description herein, references to “one embodiment,” “an embodiment,” “various implementations,” “one example,” “an example,” “some examples,” “one implementation,” “an implementation,” “some implementations,” etc., indicate that the embodiment, implementation, or example described may include a particular feature, structure, or characteristic, but every embodiment may not necessarily include the particular feature, structure, or characteristic. Moreover, such phrases are not necessarily referring to the same embodiment. Thus, when a particular feature, structure, or characteristic is described in connection with an embodiment or an implementation, it is submitted that it is within the knowledge of one skilled in the art to affect such feature, structure, or characteristic in connection with other implementations whether or not explicitly described. Similarly, the use of the term “implementation” means an implementation having a particular feature, structure, or characteristic described in connection with one or more implementations of the present disclosure. Absent an express correlation to indicate otherwise, an implementation may be associated with one or more implementations. After reading the description, it will be apparent to one skilled in the relevant art(s) how to implement the disclosure in alternative implementations.

Implementations herein are directed toward methods and techniques for calibrating a tool and a sensor of a cutting machine. More particularly, the methods and techniques descried herein determine an x-offset and a y-offset between the tool and the sensor of the cutting machine. Based on forming one or more cuts relative to a fiducial at a material surface, and comparing coordinates of the cuts to coordinates of the fiducial along the material surface, the calibration technique determines the x-offset and the y-offset. In various implementations, the calibration technique includes utilizing the sensor of the cutting machine to detect the locations/coordinates of one or more cuts (e.g., relative to one or more fiducials of a material surface).

As described herein, a fiducial may refer to any suitable visual reference point or shape that is formed at the material surface and that includes a sharp or clear demarcation between the portion of the material surface having the fiducial and portions of the material surface not having the fiducial. For example, the fiducial may be printed in ink on the material surface, etched or burned or cut away from the material surface, include another material applied to the material surface, and the like. Although shown and described as including geometric shapes and/or line segments, it should be understood that the fiducial may assume an icon, a stylized design, an irregular shape and the like.

In some implementations, the calibration technique operates the tool of the cutting machine to form a shape along the material surface, where the shape has an x-fiducial at an estimated x-coordinate along the material surface and a y-fiducial at an estimated y-coordinate along the material surface. In some implementations, a user of the cutting machine is prompted to weed or remove the cut shape from the material surface. With the shape weeded or removed from the material surface, the sensor of the cutting machine may operate to determine a measured x-coordinate and a measured y-coordinate of the respective x-fiducial and y-fiducial. The calibration technique may determine the x-offset and the y-offset based on a comparison of the measured x-coordinate and the estimated x-coordinate and the measured y-coordinate and the estimated y-coordinate.

In other aspects, the calibration technique operates the sensor of the cutting machine to determine a printed x-coordinate of a printed shape printed at a material surface and a printed y-coordinate of the printed shape. The tool of the cutting machine may be operated to form a cut shape along the material surface having a respective cut x-fiducial and cut y-fiducial. The user of the cutting machine may be prompted to weed the cut shape from the material surface. With the cut shape weeded from the material surface, the calibration technique may include operating the sensor of the cutting machine to capture further sensor data for determining a measured x-coordinate of the cut x-fiducial and a measured y-coordinate of the cut y-fiducial. The calibration technique may determine the x-offset and the y-offset of the tool and sensor of the cutting machine based on the measured x-coordinate of the cut x-fiducial and the printed x-coordinate of the printed shape and a comparison of the measured y-coordinate of the cut y-fiducial and the printed y-coordinate of the printed shape.

In various implementations, the calibration technique operates the sensor of the cutting machine to determine a printed x-coordinate of an outer x-fiducial of a printed shape printed at a material surface and a printed y-coordinate of an outer y-fiducial of the printed shape. The tool of the cutting machine may be operated to form a first cut x-line having a first cut x-coordinate along the material surface and a first cut y-line having a first cut y-coordinate along the material surface. The calibration technique may determine the x-offset and the y-offset between the tool and the sensor of the cutting machine based on a comparison of the first cut x-coordinate and the printed x-coordinate and a comparison of the first cut y-coordinate and the printed y-coordinate. The calibration technique may further include operating the sensor of the cutting machine to determine a printed x-coordinate of an inner x-fiducial of the printed shape and a printed y-coordinate of an inner y-fiducial of the printed shape. Based on the determined x-offset and the determined y-offset, the tool of the cutting machine may be operated to form a second cut x-line having a second cut x-coordinate along the material surface and a second cut y-line having a second cut y-coordinate along the material surface. The x-offset and the y-offset between the tool and the sensor of the cutting machine may be adjusted based on a comparison of the second cut x-coordinate and the printed x-coordinate of the inner x-fiducial and a comparison of the second cut y-coordinate and the printed y-coordinate of the inner y-fiducial.

As will become apparent, the methods and techniques described herein for calibrating the cutting machine provide a quick and precise determination of the x-offset and the y-offset between the tool and the sensor of the cutting machine. In various embodiments, the calibration methods and techniques described herein do not account for printer variation. That is, the disclosed calibration method(s) in accordance with various embodiments are not configured to account for variations in printers that may be utilized in conjunction with the cutting machine (e.g., for print-then-cut operations utilizing a printer separate and distinct from the cutting machine). Because the calibration techniques do not rely on user inputs or measurements, and instead utilize comparisons based on captured sensor data, offsets can be determined without being effected by human error. In some instances, the calibration techniques determine the x-offset and the y-offset without any human intervention. For example, in two minutes or less the calibration techniques may determine the x-offset and the y-offset with an accuracy of 0.04 millimeters or better. Moreover, initial machine calibration can be set based on historical data, resulting in even faster and more accurate calibration of cutting machines. After performing the calibration technique, the cutting machine may be utilized to accurately transfer user-created designs and graphics onto work surfaces.

Further, the methods and techniques described herein may be suitable for calibrating cutting machines utilized for print-then-cut operations. Typically, print-then-cut operations are designed to cut or remove portions from a material surface based on an existing design printed onto the material surface. For example, the existing printed design may be positioned at a central region of the material surface and the cutting operation may trace an outline of the printed design so that the printed design may be separated from the rest of the material surface. Calibration of the cutting machine improves precision during subsequent cutting operations. The design may be printed onto the material surface via an alternate function of the cutting machine or the design may be printed onto the material surface via a separate printing apparatus.

In some examples, calibration of the cutting machine is initiated by a user via selections made at a graphical user interface hosted at a user device or at the cutting machine. In further examples, the cutting machine prompts the user to initiate the calibration sequence. Optionally, the cutting machine may be calibrated without user intervention or prompting, such as within a factory or manufacturing setting.

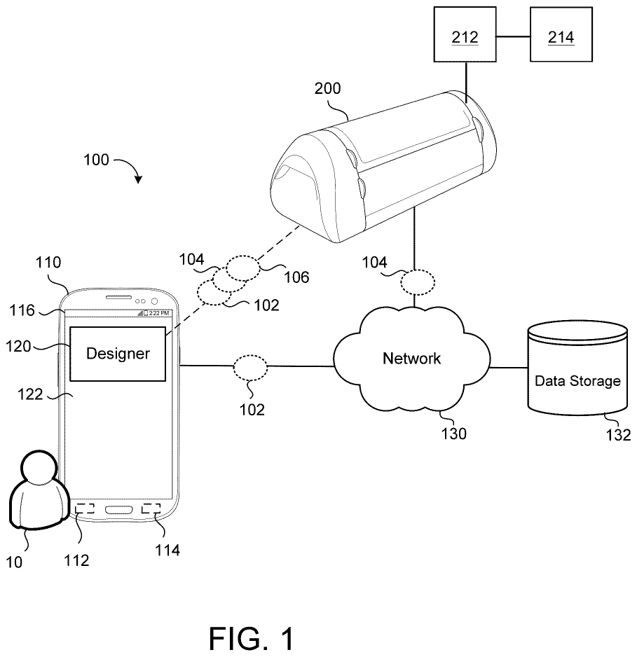

FIG. 1 provides an example design preparation environment 100 (also referred to as “environment 100”) that includes a user 10 using a user device 110 to interact with and/or otherwise control a post-design processing machine or cutting machine 200. In various implementations, the user device 100 may be utilized by the user 10 to create a unique design 102 (i.e., a graphical design) during a design process. The user device 110 may include data processing hardware 112 and memory hardware 114 in communication with the data processing hardware 112. The memory hardware 114 may store instructions thereon that, when executed on/by the data processing hardware 112, causes the data processing hardware 112 to execute a design generating program 120 (also referred to as “designer 120”) for creating the unique design 102 during the design process. Once the design 102 from the design process is complete or the user 10 wants to implement the design 102, the user device 110 may provide the design 102 for post-design processing operations that may include a printing and/or a converting process (e.g., forming, cutting, printing, etc.) to implement the design on a material. That is, the post-design processing operation(s) may convert the design 102 into a physical product or other tangible medium.

For instance, in the example shown, the designer 120 communicates the design 102 to a post-design processing machine or cutting machine 200 configured to implement the received design 102 on a material. The designer 120 may communicate the design 102 to the machine 200 via an indirect connection (e.g., a network 130 in communication with data storage 132) or a direct connection (e.g., using a wired connection as shown by the dotted line of FIG. 1). In the example shown, the post-design processing machine 200 includes a cutting machine configured to cut the unique design 102 from a cutting material. The post-design processing machine 200 may be capable of performing, without limitation, one or more of the following actions on a material: electronic cutting; laser cutting; cutting; milling; embossing; stitching; heat-pressing; printing; drawing; or three-dimensional printing.

The user device 110 may correspond to any computing device associated with the user 10 and capable of executing a controller program and/or the design generating program (i.e., the designer) 120 to generate the unique design 102. Some examples of user devices 110 include, but are not limited to, mobile phones, tablets, headsets, laptops, desktop computers, etc. In some examples, the design generating program 120 executes on the post-design processing machine 200. Here, the designer 120 may refer to a software application hosted on the user device 110 or some portion of a software application hosted on the user device 110. For instance, the designer 120 may include a module within larger graphics editor software. Additionally or alternatively, the designer 120 may be a proprietary application or a portion of a proprietary application. For instance, the designer 120 may include proprietary application specific to the post-design processing machine 200. In some implementations, the designer 120 runs on the post-design processing machine 200.

The designer 120 may be generally configured to perform control, calibration, and/or design functions, such as layout, editing, formatting, importing/exporting features (e.g., images, shapes, text, etc.), etc. In some implementations, the designer 120 is configured to display on a screen/display 116 in communication with the data processing hardware 112 a graphical user interface 122 that enables the user 10 to interact with the designer 120 to perform the control, calibration, and/or design functions. Here, the user 10 may interact with the graphical user interface 122 on the display 116 of the device 110 as the data processing hardware 112 of the device 110 executes the designer 120.

To improve transfer of the design 102 onto material surfaces (e.g., to improve accuracy in location of the design 102 at the material surface), the cutting machine 200 may undergo a calibration technique or sequence. In various examples, the designer 120, the user 10, and/or the cutting machine 200 may initiate the calibration technique. For example, during a setup process where the designer 120 is making initial connection to the cutting machine 200, the designer 120 may prompt the user 10 to initiate the calibration technique, such as via a message and/or selectable command displayed through the graphical user interface 122 at the display 116 of the device 110. Optionally, the designer 120 may automatically initiate the calibration technique for the cutting machine 200 without initiation or input by the user 10. Accordingly, the designer 120 may transmit instructions 104 (e.g., stored on the memory hardware 114) to the cutting machine 200 for performing portions of the calibration technique and the cutting machine 200 may transmit sensor data 106 to the designer 120 for processing (e.g., at the data processing hardware 112) during the calibration technique. Further, the calibration technique may be initiated at the cutting machine 200 itself (with or without input by the user 10), such as based on instructions 104 stored in data storage 132 in communication with the cutting machine 200 via the network 130 and executed on data processing hardware 212 of the cutting machine 200. Similarly, the cutting machine 200 may include memory hardware 214 in communication with the data processing hardware 212 that stores the instructions 104 for execution on the data processing hardware 214 for performing the calibration technique.

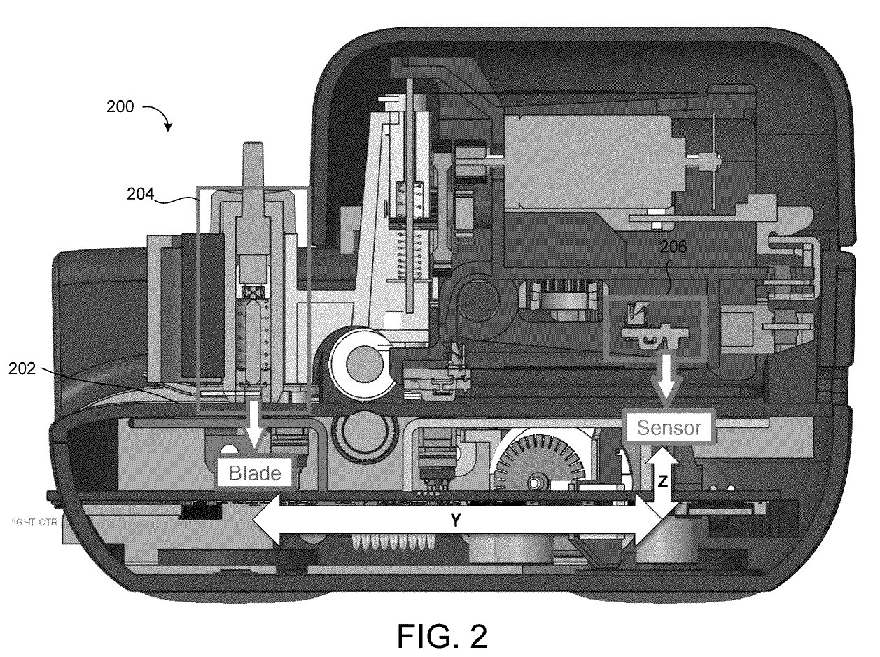

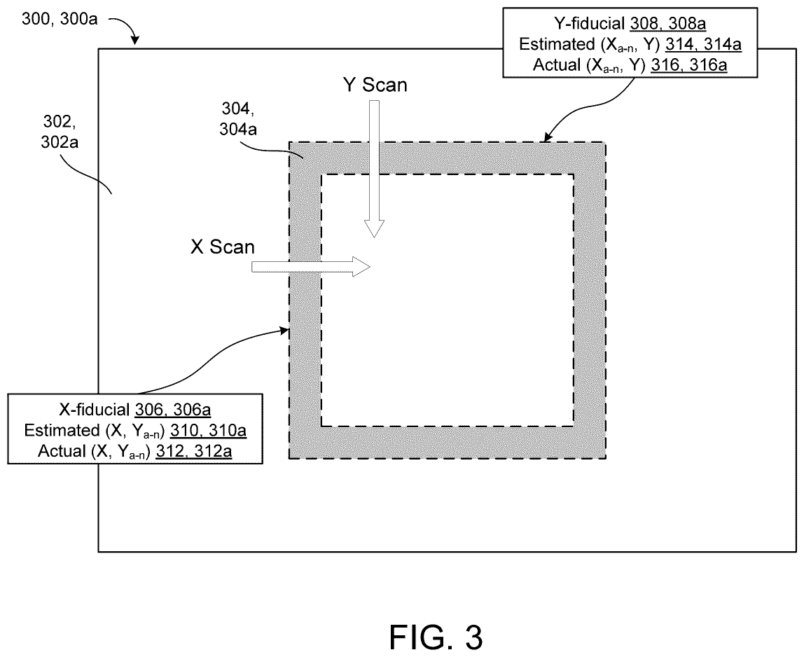

Referring to FIGS. 2 and 3, the cutting machine 200 includes a tray 202 configured to receive and support a work piece or work material 300, such as a sheet of paper, vinyl, wood, metal, fabric, and the like. A tool 204 of the cutting machine 200, such as a blade, engraving tip, scoring wheel, printer head and the like, is configured to move along a two-dimensional (2D) plane to position the tool 204 relative to the material 300. That is, and as shown in FIG. 2, the tool 204 moves along the material 300 relative to an x-axis and a y-axis of the 2D plane while the tool 204 is moved vertically (i.e., along a z-axis perpendicular to the 2D plane) relative to the tray 202 for engaging and disengaging an upper surface 302 of the material 300 that is opposite the tray 202. The x-axis extends into and out of the page of FIG. 2. The cutting machine 200 may monitor position of the tool 204 relative to the 2D plane via an encoder or other suitable means.

The cutting machine 200 further includes a sensor 206, such as a camera, laser scanner, color sensor, charge coupled device scanner (CCD scanner), and the like, for determining positioning of the tool 204 relative to features of the material 300. The sensor 206 may be configured to capture a one-dimensional array of information along a particular axis and/or may be configured to capture a two-dimensional image of the area to be analyzed. Thus, while directional “scan” arrows are depicted in the figures and indicate operation of the sensor 206 according to various implementations, in various other implementations the sensor 206 does not necessarily need to perform a scan along a direction, but instead may capture data pertaining to a certain area and thus directional scans may not be needed. In various implementations, the sensor 206 may scan the work material 300 and, based on sensor data captured during the scan, determine positions of features at the surface 302 of the material 300 along the 2D plane. These determined positions may be compared to estimated/expected positions of these features and/or may be compared to the tracked position of the tool 204 along the 2D plane to adjust positioning of the tool 204 relative to the features of the material 300. In various embodiments, the sensor 206 is rearward of the tool 204 (along the y-axis) Said differently, the cutting machine 200 may include a front side and a rear side, and the material 300 may be loaded/inserted into the machine from the front side of the cutting machine 200. In such implementations, the tool 204 may be disposed forward of the sensor 206 of the machine 200

By way of example, and with reference to FIGS. 2-5D, the graphic design 102 may include features to be formed at the material surface 302 by engaging the tool 204 with the surface 302 at specific positions or coordinates of the 2D plane. Scanning the surface 302 of the material 300 with the sensor 206 may determine an origin point or other reference feature at the material 300 or tray 202 (or an origin point of the tray 202 may be known and the material 300 may be positioned relative to the origin) so that the tool 204 can be moved along the 2D plane relative to the reference to form the graphic design 102.

To position the tool 204 accurately at the surface 302, an x-offset and a y-offset between the tool 204 and the sensor 206 is applied. As described below, one or more calibration techniques may determine the x-offset and the y-offset. The more accurate the determined x-offset and y-offset are to actual offsets of the tool 204 and the sensor 206, the more accurately the tool 204 can be positioned at the surface 302 of the material 300. In other words, error between desired positioning of the tool 204 and actual positioning of the tool 204 can be minimized or eliminated via the calibration techniques described below, thereby helping the cutting machine 200 to accurately implement a design (e.g., a graphic design 102) into or onto the material.

Referring to FIG. 3, in some implementations, the calibration technique prompts the user 10 to load a work material 300, 300a (e.g., a sheet of paper) at the tray 202 of the cutting machine 200. For example, after initiating the calibration technique, the designer 120 may display a message to the user 10 indicating that the user 10 should load the work material 300a into the cutting machine 200. In the illustrated example, and according to various implementations, the work material 300a is a blank or unprinted sheet of paper 300a, meaning that a surface 302, 302a of the material 300a does not have any markings or cuts prior to the calibration sequence. Accordingly, as mentioned above, the calibration technique may not account for printer variation, but the calibration technique may be performed without requiring a separate printing step, without requiring a specific calibration sheet, and without requiring the user to make a manual/visual assessment.

With the work material 300a loaded at the cutting machine 200 and the calibration technique initiated by the cutting machine 200 and/or user 10, the tool 204 of the cutting machine 200 is operated to form a shape 304, 304a along the surface 302a.

For example, with the tool 204 having a blade, the shape 304a may include one or more cuts into or along the surface 302a. In various implementations, the shape 304a cut into the material 300a extends completely through the material 300a (e.g., the sheet of paper) or at least through a top layer of the material 300a. In various embodiments, before loading the material 300a at the cutting machine 200, the material 300a may be removably attached to a support mat, which may be referred to herein as a crafting mat or an adhesive mat. The support mat may be configured to detachably secure the material 300a thereto (e.g., using a pressure sensitive adhesive) and may be configured to support the material 300a while the material 300a is processed by the cutting machine 200. Said differently, the support mat may be disposed between the floor/tray 202 of the cutting machine 200 and the material 300a. In such implementations, the tool 204 may cut completely through the material 300a during the calibration technique but does not cut through the support mat.

The cut shape 304a may comprise an x-fiducial 306, 306a and a y-fiducial 308, 308a along the surface 302a, meaning that the shape 304 includes respective reference points for determining the x-offset and the y-offset between the tool 204 and the sensor 206 of the cutting machine 200. The shape 304a may include a continuous shape along the surface 302a such that cuts formed by the tool 204 are connected and the shape 304a includes both the x-fiducial 306a and the y-fiducial 308a. That is, according to various embodiments, the cut shape 304a is a closed shape. In other examples, the shape is not a continuous shape such that cuts formed by the tool 204 are not connected and the shape includes a first shape having the x-fiducial and a second shape having the y-fiducial.

The x-fiducial 306a may include a line or edge formed along the y-axis of the 2D plane so that the x-offset may be determined based on a difference between an estimated x-coordinate 310, 310a of the x-fiducial 306a and an actual or measured x-coordinate 312, 312a of the x-fiducial 306a, and the y-fiducial 308a may include a line or edge formed along the x-axis of the 2D plane so that the y-offset may be determined based on a difference between an estimated y-coordinate 314, 314a of the y-fiducial 308a and an actual or measured y-coordinate 316, 316a of the y-fiducial 308a.

Put another way, the x-fiducial 306a is formed by the tool 204 of the cutting machine 200 with positioning of the x-fiducial 306a along the surface 302a estimated to be at a set of x-coordinates 310a (e.g., an estimated x-coordinate X and a corresponding set of y-coordinates Yₐ₋ₙ of a line or edge along a y-axis of the 2D plane along the surface 302a) and the y-fiducial 308a is formed by the tool 204 with positioning of the y-fiducial 308a along the surface 302a estimated to be at a set of y-coordinates 314a (e.g., a set of estimated x-coordinates Xₐ₋ₙ and a corresponding y-coordinate Y of a line or edge along the x-axis of the 2D plane along the surface 302a). As shown in FIG. 3, the dashed lines represent cuts made by the tool 204 such that the shape 304a includes an outer closed shape (e.g., a square) and an inner closed shape (e.g., a square) so that a perimeter region of the shape 304a shown darkened is defined therebetween. Accordingly, in various implementations, the cut shape 304a include a first closed shape and a second closed shape circumscribing the first closed shape, with the area disposed between the two closed shapes forming an annulus region (e.g., a rectangular annulus region). In various implementations, the calibration technique further includes prompting the user to weed the annular region, as described in greater detail below. Said differently, the calibration technique may include making cuts in the material 300a with the tool 204 so that a portion (e.g., the cut annulus region) of the material is removable from the floor/tray 202 of the machine or removable from a support mat to which the material is attached.

To determine the actual x-coordinate 312a of the x-fiducial 306a and the actual y-coordinate 316a of the y-fiducial 308a, the user 10 is prompted to weed or remove the shape 304a from the floor/tray 202 or the support mat. For example, with the shape 304a cut and without removing the material 300a from the cutting machine 200, the user 10 may lift and remove the shape 304a (e.g., an annular region defined between two closed shapes) from the floor/tray 202 or the support mat, such as by using tweezers, a pick, a spatula, and the like. In various implementations, the cutting machine 200 is configured, according to the calibration technique, to partially eject the material 300a from the cutting machine 200 after the shape 304a has been cut into the material 300a.

For example, drive rollers of the cutting machine 200, which engage edges of the support mat to which the material 300a is attached, may push at least a portion (e.g., a majority portion) of the support mat out of the cutting machine 200 (e.g., out of the front side of the cutting machine) such that the user has access to the shape 304a cut into the material 300a while the support mat, and therefore the material 300a, is still retained by the cutting machine 200 (e.g., still engaged between a drive roller and pinch roller of the cutting machine 200). In various implementations, the calibration technique includes prompting the user 10 (e.g., via the graphical user interface 122) to weed/remove the shape 304a while the support mat is still retained by the cutting machine 200. With the shape 304a weeded/removed, the user 10 may provide an input at the graphical user interface 122, or may simply apply an insertion/re-loading force on the support mat, to continue the calibration technique and the sensor 206 of the cutting machine 200 may be operated to capture sensor data representative of the material surface 302a.

In other words, with the shape 304a weeded, the sensor 206 scans the material surface 302a. Based on the captured sensor data, the actual or measured x-coordinate 312a of the x-fiducial 306a (e.g., a measured x-coordinate X and a corresponding set of y-coordinates Yₐ₋ₙ of a line or edge along a y-axis of the 2D plane along the surface 302a) and the actual or measured y-coordinate 316a of the y-fiducial 308a (e.g., a set of measured x-coordinates Xₐ₋ₙ and a corresponding y-coordinate Y of a line or edge along the x-axis of the 2D plane along the surface 302a) are identified. In various implementations, the sensor 206 is capable of precisely detecting the coordinates of the cut fiducials because the contrasting appearance between the surface of the material 300a and the support mat being visible through the removed/weeded shape 304a provides a clear and easily detectable edge.

Based on a comparison of the estimated x-coordinate 310a and the measured x-coordinate 312a of the x-fiducial 306a and a comparison of the estimated y-coordinate 314a and the measured y-coordinate 316a of the y-fiducial 308, the calibration technique determines the x-offset and the y-offset between the tool 204 and the sensor 206 of the cutting machine 200. For example, the estimated x-coordinate 310a and the estimated y-coordinate 312a may be configured such that the cutting machine 200 attempts to center the shape 304a at the material surface 302a. The x-offset may be equal to a difference between the X value of the estimated x-coordinate 310a and the X value of the measured x-coordinate 312a and the y-offset may be equal to a difference between the Y value of the estimated y-coordinate 314a and the Y value of the measured y-coordinate 316a.

Accordingly, the x-offset and the y-offset may be applied to coordinates of graphic designs 102 when transferring the graphic designs 102 onto work materials following performance of the calibration technique.

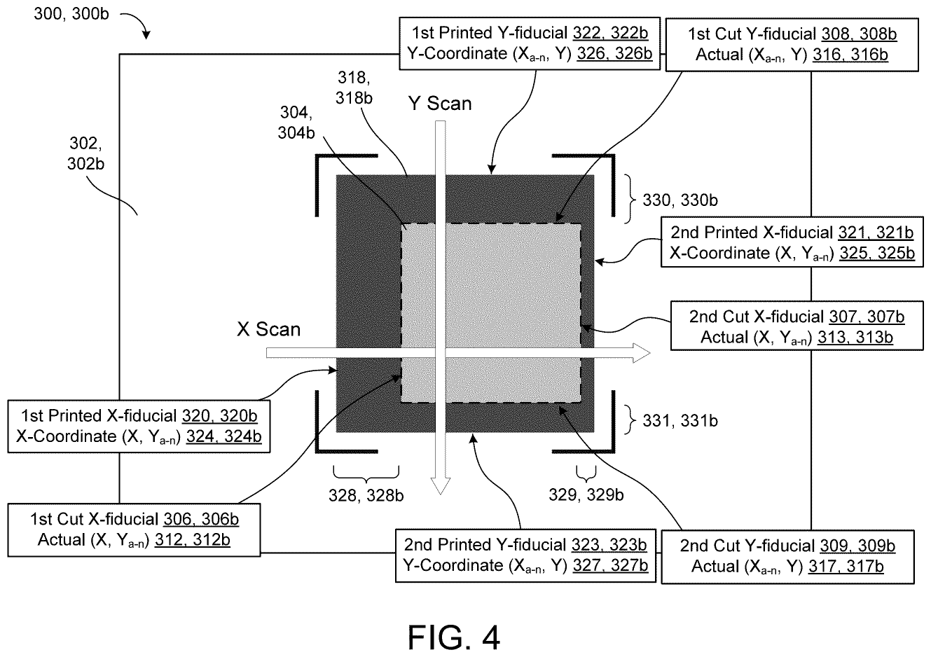

Referring to FIG. 4, another example of the calibration technique prompts the user 10 to load a work material 300, 300b (e.g., a sheet of paper) at the tray 202 of the cutting machine 200, where the surface 302, 302b of the work material 300b has a printed shape 318, 318b formed thereon. The printed shape 318b has a first printed x-fiducial 320, 320b, a second printed x-fiducial 321, 321b, a first printed y-fiducial 322, 322b, and a second printed y-fiducial 323, 323b, meaning that the printed shape 318b includes respective edges or lines or reference points for reference in determining the x-offset and the y-offset between the tool 204 and the sensor 206 of the cutting machine 200. In the illustrated example, the surface 302b is printed to have a solid-colored shape (e.g., a rectangular or square shape) with markers outboard of its four corners. Accordingly, the printed shape 318b, which may comprise the printed fiducials, may include a solid-colored shape and corner markers offset and outward from the corners of the solid-colored shape. The corner markers which are offset and outward from the corners of the solid-colored shape, according to various implementations, may be crucial for locating the position of the solid-colored shape.

After the user 10 has loaded the material 300b, the calibration technique may include the cutting machine 200 operating the sensor 206 to scan the material 300b and locate the printed shape 318b. That is, the sensor 206 of the cutting machine 200 is operated to scan the material surface 302b and capture sensor data. Based on the captured sensor data, the calibration technique determines a set of x-coordinates 324, 324b (“a printed x-coordinate”) for the first printed x-fiducial 320b (e.g., a measured x-coordinate X and a corresponding set of y-coordinates Yₐ₋ₙ of a line or edge along a y-axis of the 2D plane along the surface 302b), a set of x-coordinates 325, 325b for the second printed x-fiducial 321b, a set of y-coordinates 326, 326b (“a printed y-coordinate”) for the first printed y-fiducial 322b (e.g., a set of measured x-coordinates Xₐ₋ₙ and a corresponding y-coordinate Y of a line or edge along the x-axis of the 2D plane along the surface 302b), and a set of y-coordinates 327, 327b for the second printed y-fiducial 323b. Because the printed shape 318b is a 2D shape, the x-coordinate 324b of the first printed x-fiducial 320b is spaced from the x-coordinate 325b of the second printed x-fiducial 321b and the y-coordinate 326b of the first printed y-fiducial 322b is spaced from the y-coordinate 327b of the second printed y-fiducial 323b.

After locating the printed shape 318b, the calibration technique may include operating the tool 204 of the cutting machine 200 to form a cut shape 304, 304b along the surface 302b, where the cut shape 304b has a first cut x-fiducial 306, 306b, a second cut x-fiducial 307, 307b, a first cut y-fiducial 308, 308b, and a second cut y-fiducial 309, 309b along the surface 302b. For example, the cutting machine 200 may be operated to attempt to form the cut shape 304b at a desired location relative to the printed fiducials. For example, the cutting machine 200 may be configured to form the cut shape 304b within a boundary of the printed shape 318b, such as a square shape 304b at the center and radially inboard of the square printed shape 318b (e.g., the cutting machine 200 may attempt to form the cut shape 304b within and concentric with the printed shape 318b).

In other words, the goal of the cutting machine 200 during this step of the calibration technique is to form the cut shape 304b such that a distance 328, 328b between the first printed x-fiducial 320b and the first cut x-fiducial 306b is equal to a distance 329, 329b between the second printed x-fiducial 321b and the second cut x-fiducial 307b, and a distance 330, 330b between the first printed y-fiducial 322b and the first cut y-fiducial 308b is equal to a distance 331, 331b between the second printed y-fiducial 323b and the second cut y-fiducial 309b.

To determine a measured x-coordinate 312, 312b of the first cut x-fiducial 306b, a measured x-coordinate 313, 313b of the second cut x-fiducial 307b, a measured y-coordinate 314, 314b of the first cut y-fiducial 308b, and a measured y-coordinate 315, 315b of the second cut y-fiducial 309b, the calibration technique may include prompting the user 10 to weed or remove the shape 304b from the floor/tray 202 of the cutting machine 200 or from the support mat disposed on the floor/tray 202 of the cutting machine 200. For example, the user 10 may be prompted to weed the shape 304b without completely removing the material 300b from the cutting machine 200, as described above with reference to FIG. 3. With the shape 304b weeded/removed, the user 10 may provide an input at the graphical user interface 122, or may simply apply an insertion/re-loading force on the support mat, to continue the calibration technique and the sensor 206 of the cutting machine 200 may be operated to capture sensor data representative of the material surface 302b.

In other words, with the shape 304b weeded, the sensor 206 scans the material surface 302b. Based on the captured sensor data, the actual or measured x-coordinate 312b of the first cut x-fiducial 306b (e.g., a measured x-coordinate X and a corresponding set of y-coordinates Yₐ₋ₙ of a line or edge along a y-axis of the 2D plane along the surface 302b), the measured x-coordinate 313b of the second cut x-fiducial 307b, the actual or measured y-coordinate 316b of the first cut y-fiducial 308b (e.g., a set of measured x-coordinates Xₐ₋ₙ and a corresponding y-coordinate Y of a line or edge along the x-axis of the 2D plane along the surface 302b), and the measured y-coordinate 317b of the second cut y-fiducial 309b are identified. Because the cut shape 304b is a 2D shape, the x-coordinate 312b of the first cut x-fiducial 306b is spaced from the x-coordinate 313b of the second cut x-fiducial 307b and the y-coordinate 316b of the first cut y-fiducial 308b is spaced from the y-coordinate 317b of the second cut y-fiducial 309b.

Based on a comparison of at least the x-coordinate 324b of the first printed x-fiducial 320b and the measured x-coordinate 312b of the first cut x-fiducial 306b and the y-coordinate 326b of the first printed y-fiducial 322b and the measured y-coordinate 316b of the first cut y-fiducial 308b, the x-offset and the y-offset between the tool 204 and the sensor 206 of the cutting machine 200 are determinable. For example, the x-offset and the y-offset may be determined based on differences between the distance 328b and the distance 330b and expected values. Further, the x-offset and the y-offset may be determined based on a comparison between the x-coordinate 325b of the second printed x-fiducial 321b and the measured x-coordinate 313b of the second cut x-fiducial 307b and the y-coordinate 327b of the second printed y-fiducial 323b and the measured y-coordinate 317b of the second cut y-fiducial 309b. For example, the x-offset may be equal to half of the difference between the distance 328b and the distance 329b and the y-offset may be equal to half of the difference between the distance 330b and the distance 331b. Again, the contrast between the solid-colored printed shape 318b and the underlying support mat visible through the removed cut shape 304b may enable the sensor 206 to easily and accurately determine the coordinates of the cut fiducials.

Put another way, the calibration technique described in FIG. 4 includes operating the cutting machine 200 to scan the printed x-fiducials 320b, 321b and the printed y-fiducials 322b, 323b at the surface 302b of the material 300b using the sensor 206 of the cutting machine 200. With the x-offset and the y-offset between the tool 204 and the sensor 206 of the cutting machine 200 set to a default configuration or setting, the calibration technique includes operating the cutting machine 200 to cut the shape 304b within the printed shape 318b (i.e., within the bounds of the printed x-fiducials 320b, 321b and the printed y-fiducials 322b, 323b) using the cutting tool 204 of the cutting machine 200. The calibration technique may then be paused to allow the user 10 to weed or remove the cut shape 304b from the material 300b, thus exposing the tray 202 at the previous position of the cut shape 304b.

After the cut shape 304b is weeded from the material 300b, the calibration technique operates the cutting machine 200 to perform a horizontal scan (e.g., in the x-axis direction) to measure thicknesses of the right and left sides of the now hollow printed shape 318b. That is, the horizontal scan may operate the sensor 206 to begin capturing sensor data outboard of the printed shape 318b (i.e., at the white paper 300b) and move the sensor 206 along the x-axis while searching for the printed edge of the first printed x-fiducial 320b, demarcated by the transition between the unprinted material 300b and the printed shape 318b. In response to detecting the printed edge of the first printed x-fiducial 320b, the calibration technique may continue moving the sensor 206 along the x-axis and measure the printed shape 318b while searching for the first cut x-fiducial 306b, demarcated by the transition between the printed shape 318b and the tray 202 visible where the cut shape 304b was formerly located. The thickness of one side of the remaining printed shape 318b is now measured. The calibration technique may then continue moving the sensor 206 along the x-axis while searching for the second cut x-fiducial 307b demarcated by the transition between the tray 202 and the printed shape 318b. After detecting the printed shape 318b, the calibration technique may continue moving the sensor 206 along the x-axis and measure the printed shape 318b while searching for the second printed x-fiducial 321b, demarcated by the transition between the printed shape 318b and the unprinted material 300b. The thickness of the other side of the remaining printed shape 318b is now measured.

Further, the calibration technique operates the cutting machine 200 to perform a vertical scan (e.g., in the y-axis direction) to measure thicknesses of the top and bottom sides of the hollow printed shape 318b. That is, the vertical scan may operate the sensor 206 to begin capturing sensor data outboard of the printed shape 318b (i.e., at the white paper 300b) and move the sensor 206 along the y-axis while searching for the printed edge of the first printed y-fiducial 322b, demarcated by the transition between the unprinted material 300b and the printed shape 318b. In response to detecting the printed edge of the first printed y-fiducial 322b, the calibration technique may continue moving the sensor 206 along the y-axis and measure the printed shape 318b while searching for the first cut y-fiducial 308b, demarcated by the transition between the printed shape 318b and the tray 202 visible where the cut shape 304b was formerly located. The thickness of one side of the remaining printed shape 318b is now measured. The calibration technique may then continue moving the sensor 206 along the y-axis while searching for the second cut y-fiducial 309b demarcated by the transition between the tray 202 and the printed shape 318b. After detecting the printed shape 318b, the calibration technique may continue moving the sensor 206 along the y-axis and measure the printed shape 318b while searching for the second printed y-fiducial 323b, demarcated by the transition between the printed shape 318b and the unprinted material 300b. The thickness of the other side of the remaining printed shape 318b is now measured.

With the thicknesses of the sides of the remaining printed shape 318b measured, the calibration technique determines how far off-center the cut shape 304b is from the printed shape 318b. For example, the calibration technique may determine that one of the left side and the right side is thicker than the other, indicating an x-offset between the tool 204 and the sensor 206 of the cutting machine 200, and that one of the top side and the bottom side is thicker than the other, indicating a y-offset between the tool 204 and the sensor 206 of the cutting machine 200. The determined x-offset and y-offset may be stored in persistent memory of the cutting machine 200.

After determining the x-offset and the y-offset, the calibration technique optionally scans the printed x-fiducials 320b, 321b and the printed y-fiducials 322b, 323b again. Using the determined x-offset and the determined y-offset, the calibration technique operates the cutting machine 200 to cut the printed shape 318b using the cutting tool 204. The user 10 (or the sensor 206) may determine whether the cutting machine has successfully cut the printed shape 318b (e.g., the cut is made at or near the printed x-fiducials 320b, 321b and the printed y-fiducials 322b, 323b).

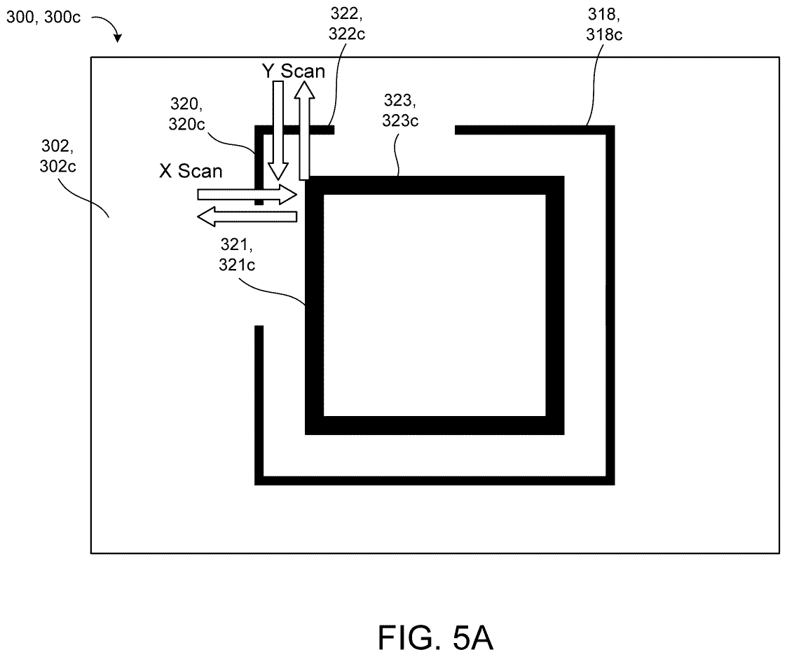

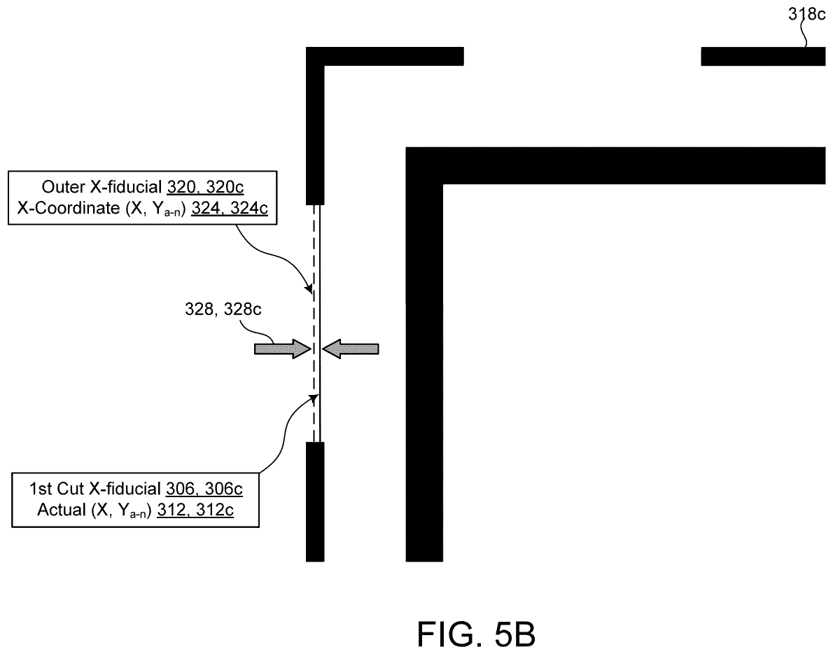

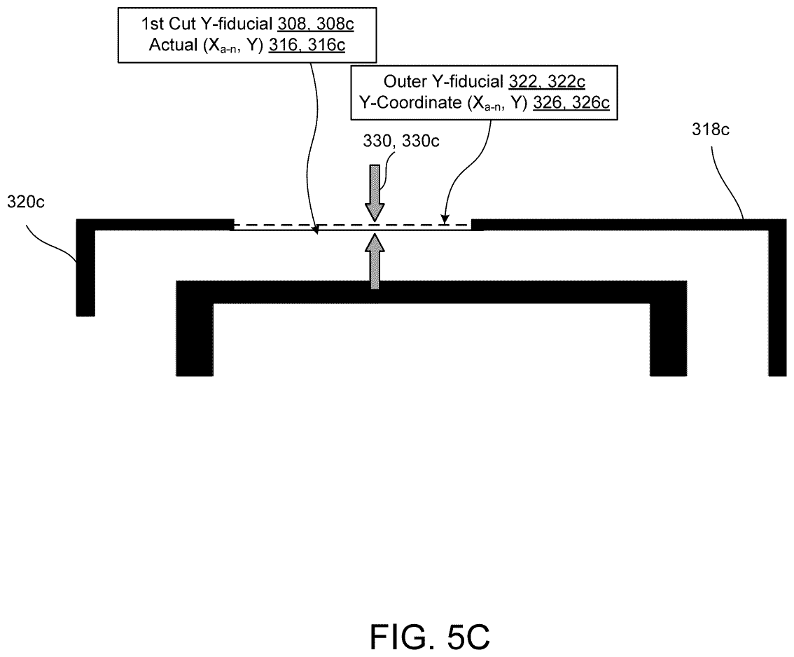

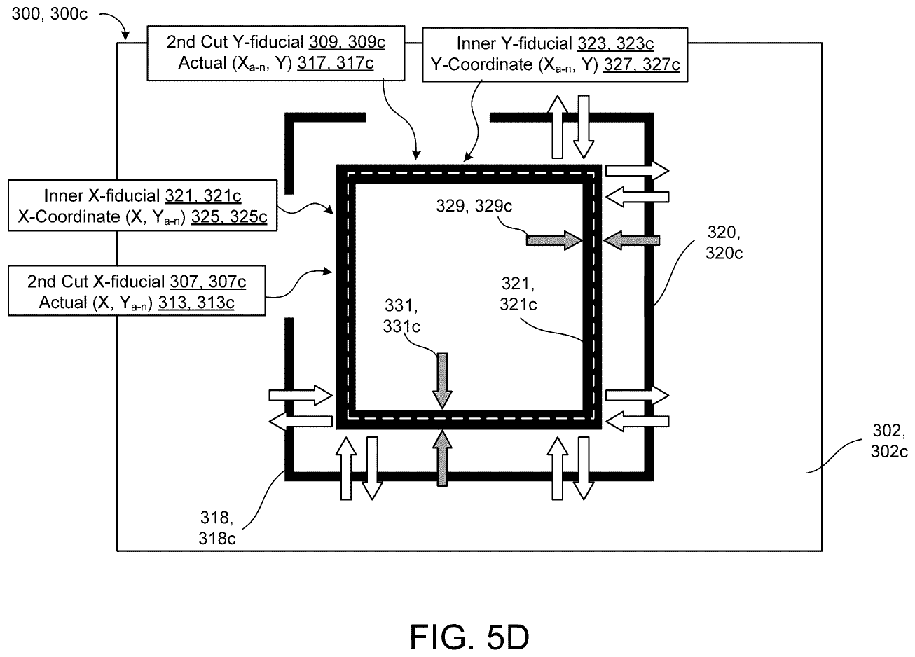

In reference to FIGS. 5A-5D, other aspects and implementations of the calibration technique further reduce involvement by the user 10 and thus further improve reliability and accuracy. For example, a work material 300, 300c (e.g., a sheet of paper) may be preloaded at the tray 202 (or the user 10 may be prompted to load the work material 300c). A surface 302, 302c of the work material 300c has a printed shape 318, 318c formed thereon. In the illustrated example, the printed shape 318c includes an outer x-fiducial 320, 320c, an inner x-fiducial 321, 321c, an outer y-fiducial 322, 322c, and an inner y-fiducial 323, 323c. As described below, the outer portions of the printed shape 318c may enable a first calibration or initial determination of the x-offset and the y-offset and the inner portions of the printed shape 318c may enable a second calibration or adjustment of the x-offset and the y-offset. As shown, the surface 302c is printed to have an inner portion resembling the outline of a square surrounded by a partially formed perimeter shape. That is, the outer portions of the printed shape 318c may resemble the outline of a square surrounding the inner square, with gaps formed in the outline.

With the material 300c loaded onto the tray 202 or loaded onto a support mat, the sensor 206 of the cutting machine 200 may be operated as a step of the calibration technique to scan the surface 302c and capture sensor data. Based on the captured sensor data, the calibration technique may determine a set of x-coordinates 324, 324c (“a printed x-coordinate”) for the outer printed x-fiducial 320c (e.g., a measured x-coordinate X and a corresponding set of y-coordinates Yₐ₋ₙ of a line or edge along a y-axis of the 2D plane along the surface 302c), and a set of y-coordinates 326, 326c (“a printed y-coordinate”) for the outer printed y-fiducial 322c (e.g., a set of measured x-coordinates Xₐ₋ₙ and a corresponding y-coordinate Y of a line or edge along the x-axis of the 2D plane along the surface 302c). As shown in FIGS. 5B and 5C, the printed x-coordinate 324c of the outer printed x-fiducial 320c and the printed y-coordinate 326c of the outer printed y-fiducial 322c may be determined based on midlines or midpoints of the respective fiducials, with the calibration technique targeting an upper portion of the outer fiducial.

The calibration technique may include operating the tool 204 of the cutting machine 200 to form a first cut x-line or first cut x-fiducial 306, 306c (FIG. 5B) and a first cut y-line or first cut y-fiducial 308, 308c along the material surface 302c (FIG. 5C). In various implementations, forming the first cut x-fiducial 306c and the first cut y-fiducial 308c attempts to make cuts in the surface 302c at or along the respective midpoints or midlines of the outer printed x-fiducial 320c and the outer printed y-fiducial 322c, that is at or near the printed x-coordinate 324c and the printed y-coordinate 326c.

In various implementations, the calibration technique further includes operating the sensor 206 to capture sensor data and determine an actual or measured x-coordinate 312, 312c (FIG. 5B) of the first cut x-fiducial 306c (e.g., a measured x-coordinate X and a corresponding set of y-coordinates Yₐ₋ₙ of a line or edge along a y-axis of the 2D plane along the surface 302c) and an actual or measured y-coordinate 316, 316c (FIG. 5C) of the first cut y-fiducial 308c (e.g., a set of measured x-coordinates Xₐ₋ₙ and a corresponding y-coordinate Y of a line or edge along the x-axis of the 2D plane along the surface 302c).

Optionally, the measured x-coordinate 312c of the first cut x-fiducial 306c and the measured y-coordinate 316c of the first cut y-fiducial 308c are determined based on sensor data captured by a secondary sensor, such as image data captured by a camera or imaging sensor viewing the material 300c. For example, the secondary sensor may be incorporated with the cutting machine 200, such as mounted at a carriage of the cutting machine 200 at or near the sensor 206, or the secondary sensor may be separate from the cutting machine 200, such as a handheld unit operated by the user 10. The user 10 and/or the cutting machine 200 may manipulate the camera relative to the material 300c without completely removing the material 300c and/or the support mat from the cutting machine 200. Accordingly, in various implementations, the secondary sensor views the first cut x-fiducial 306c and the outer x-fiducial 320c and views the first cut y-fiducial 308c and the outer y-fiducial 322c so that captured image data may be processed for determining relative positioning and/or alignment between the first cut x-fiducial 306c and the outer x-fiducial 320c and between the first cut y-fiducial 308c and the outer y-fiducial 322c for determining the measured x-coordinate 312c of the first cut x-fiducial 306c and the measured y-coordinate 316c of the first cut y-fiducial 308c. Because the first cut x-fiducial 306c and the first cut y-fiducial 308c may be formed as thin cut lines, image data captured by a camera viewing the material 300c may be better suited for detecting contrast between the first cut x-fiducial 306c and the outer x-fiducial 320c, and between the first cut y-fiducial 308c and the outer y-fiducial 322c.

The x-offset of the tool 204 and the sensor 206 may be determined based on a comparison of the first cut x-coordinate 312c of the first cut x-fiducial 306c and the printed x-coordinate 324c of the outer x-fiducial 320c. For example, the x-offset may be based on a difference or distance 328, 328c between the first cut x-fiducial 306c and the midpoint of the outer x-fiducial 320c. The y-offset may be determined based on a comparison of the first cut y-coordinate 316c of the first cut y-fiducial 308c and the printed y-coordinate 326c of the outer y-fiducial 322c. The y-offset may be based on a difference or distance 330, 330c between the first cut y-fiducial 308c and the midpoint of the outer y-fiducial 322c. Thus, operating the tool 204 of the cutting machine 200 to form the first cut x-fiducial 306c and operating the tool 204 of the cutting machine 200 to form the first cut y-fiducial 308c are both performed before determining the x-offset and determining the y-offset between the tool 204 and the sensor 206 of the cutting machine 200.

In some examples, the calibration technique initially determines the x-offset and the y-offset during separate steps. That is, the calibration technique may operate the tool 204 and the sensor 206 and/or secondary sensor of the cutting machine 200 to form and measure the first cut x-fiducial 306c to determine the x-offset separately from forming and measuring the first cut y-fiducial 308c to determine the y-offset. Put another way, some aspects of the calibration technique include operating the tool 204 of the cutting machine 200 to form the first cut x-fiducial 306c and capturing sensor data (e.g., image data) to determine the x-offset between the tool 204 and the sensor 206 of the cutting machine 200 before operating the tool 204 of the cutting machine 200 to form the first cut y-fiducial 308c and capturing sensor data (e.g., image data) to determine the y-offset between the tool 204 and the sensor 206 of the cutting machine 200. In other aspects, the calibration technique includes operating the tool 204 of the cutting machine 200 to form the first cut y-fiducial 308c and capturing sensor data (e.g., image data) to determine the y-offset between the tool 204 and the sensor 206 of the cutting machine 200 before operating the tool 204 of the cutting machine 200 to form the first cut x-fiducial 306c and capturing sensor data (e.g., image data) to determine the x-offset between the tool 204 and the sensor 206 of the cutting machine 200.

With the x-offset and the y-offset initially determined, the calibration technique may operate the sensor 206 of the cutting machine 200 to scan the surface 302c and capture further sensor data (FIG. 5D). Based on the captured sensor data, the calibration technique may determine a set of x-coordinates 325, 325c (“a printed x-coordinate”) for the inner printed x-fiducial 320c (e.g., a measured x-coordinate X and a corresponding set of y-coordinates Yₐ₋ₙ of a line or edge along a y-axis of the 2D plane along the surface 302c), and a set of y-coordinates 327, 327c (“a printed y-coordinate”) for the inner printed y-fiducial 323c (e.g., a set of measured x-coordinates Xₐ₋ₙ and a corresponding y-coordinate Y of a line or edge along the x-axis of the 2D plane along the surface 302c). The printed x-coordinate 325c of the inner printed x-fiducial 321c and the printed y-coordinate 327c of the inner printed y-fiducial 323c may be determined based on midlines or midpoints of the inner fiducial 321c. For example, the inner fiducial 321c may have a width of about three millimeters or less.

Based on the initially determined x-offset and y-offset, the calibration technique may operate the tool 204 of the cutting machine 200 to form a second cut x-line or x-fiducial 307, 307c and a second cut y-line or y-fiducial 309, 309c. As shown by the dashed lines in FIG. 5D, forming the second cut x-fiducial 307c and the second cut y-fiducial 309c may be an attempt to cut along a midpoint or midline of the inner fiducial 321c. That is, the second cut x-fiducial 307c and the second cut y-fiducial 309c may form a closed shape (e.g., a rectangular or square shape) that generally follows the midline of the closed shape of the inner fiducial 321c, such that the second cut x-fiducial 307c and the second cut y-fiducial 309c may be connected and/or form portions of the same closed shape. The second cut x-fiducial 307c has an actual or measured x-coordinate 313, 313c (e.g., a measured x-coordinate X and a corresponding set of y-coordinates Yₐ₋ₙ of a line or edge along a y-axis of the 2D plane along the surface 302c) and the second cut y-fiducial 309c has an actual or measured y-coordinate 317, 317c (e.g., a set of measured x-coordinates Xₐ₋ₙ and a corresponding y-coordinate Y of a line or edge along the x-axis of the 2D plane along the surface 302c), which may be determined by further scanning the work surface 302c.

In some implementations, the measured x-coordinate 313c of the second cut x-fiducial 307c and the measured y-coordinate 317c of the second cut y-fiducial 309c are determined based on sensor data captured by the secondary sensor. As discussed above, the secondary sensor may include a camera or imaging sensor mounted at the cutting machine 200 or included as a separate unit operated by the user 10. The user 10 and/or the cutting machine 200 may manipulate the camera relative to the material 300c without completely removing the material 300c and/or the support mat from the cutting machine 200. Thus in some implementations, the secondary sensor views the second cut x-fiducial 307c and the inner x-fiducial 321c and views the second cut y-fiducial 309c and the inner y-fiducial 323c so that captured image data may be processed for determining relative positioning and/or alignment between the second cut x-fiducial 307c and the inner x-fiducial 321c and between the second cut y-fiducial 309c and the inner y-fiducial 323c for determining the measured x-coordinate 313c of the second cut x-fiducial 307c and the measured y-coordinate 317c of the second cut y-fiducial 309c. Optionally, the user 10 may weed or remove the cut shape that includes the second cut x-fiducial 307c and the second cut y-fiducial 309c before the measured x-coordinate 313c and the measured y-coordinate 317c are determined.

In some implementations, the x-offset and the y-offset are adjusted based on a comparison of the x-coordinate 313c of the second cut x-fiducial 307c and the printed x-coordinate 325c of the inner x-fiducial 321c and a comparison of the y-coordinate 317c of the second cut y-fiducial 309c and the printed y-coordinate 327c of the inner y-fiducial 323c. In other words, the x-offset may be adjusted based on a distance 329, 329c between the midpoint of the inner x-fiducial 321c and the second cut x-fiducial 307c and the y-offset may be adjusted based on a distance 331, 331c between the midpoint of the inner y-fiducial 323c and the second cut y-fiducial 309c. In various implementations, the initially determined x-offset and the y-offset may be verified or validated based on the comparison of the x-coordinate 313c of the second cut x-fiducial 307c and the printed x-coordinate 325c of the inner x-fiducial 321c and the comparison of the y-coordinate 317c of the second cut y-fiducial 309c and the printed y-coordinate 327c of the inner y-fiducial 323c. The adjusted x-offset and the adjusted y-offset between the tool 204 and the sensor 206 may be accurate within 0.04 millimeters or less.

Verification of the x-offset and the y-offset between the tool 204 and the sensor 206 of the cutting machine 200 may be performed based on sensor data captured by the secondary sensor, such as based on image data captured by a camera separate from the cutting machine 200 and operated by the user 10, such as in the factory setting.

Moreover, verification of the x-offset and the y-offset may be performed by comparing any suitable portion of the printed shape 318 and the cuts 306, 307, 308, 309, along with portions of the work material 300, the cutting machine 200, and the like. For example, the x-offset and the y-offset between the tool 204 and the sensor 206 may be further adjusted based on position of the tray 202 relative to the cutting machine 200, based on position of the work material 300 at the tray 202, and the like. This may allow the x-offset and the y-offset to correct for anomalies in the calibration procedure.

The camera or other secondary sensor used in the verification process may be a standalone unit manipulated by the user 10 in the factory. For example, the camera may be accommodated in a fixture relative to the manufacturing setting, such as to provide known or repeatable positioning of the camera relative to the cutting machine 200. Optionally, the camera or secondary sensor may be part of a mobile device such as a cell phone.

In some examples, the x-offset and the y-offset are further adjusted based on historical data. For example, an average x-offset and average y-offset may be determined based on sensor data captured during historical calibration techniques. This may be used to initially set the x-offset and the y-offset and then a new or additional calibration technique may be performed at the cutting machine 200 to further adjust or fine tune the x-offset and the y-offset.

Accordingly, the methods and techniques described herein allow for quick and accurate calibration of the cutting machine 200 so that the graphic design 102 may be accurately translated onto work materials 300. The calibration techniques may be implemented through the designer 120 so that the user 10 may monitor and/or provide inputs to the calibration technique through the user device 110. For example, the designer 120 may prompt the user 10 to perform the calibration technique and/or allow the user 10 to select and command operation of the calibration technique. The calibration technique utilizes the sensor 206 at the cutting machine 200 to measure offsets between estimated positions of cuts and actual positions of cuts to determine the x-offset and y-offset between the sensor 206 and the tool 204. Some examples of the calibration technique prompt the user 10 to weed or remove cuts from the material 300 so that the removed shape can be sensed and compared to estimated positions of the shape. The user 10 may cycle through steps of the calibration technique via prompts and commands at the graphical user interface 122. Further examples of the calibration technique determine the x-offset and the y-offset without weeding of the cut shapes, such as to further reduce user input and the introduction of human error. In various implementations, a first calibration technique may be performed at a manufacturing plant where cutting machines 200 are made (e.g., a factory) and a second calibration technique may be performed by an end user 10 at home. For example, a calibration method may include performing one or more steps of the calibration technique(s) described above with reference to FIGS. 5A-5D in a factory/manufacturing setting and subsequently performing one or more steps of the calibration technique(s) described above with reference to FIGS. 3 and 4 by an end-user 10 in their home. In such embodiments, the first/factory calibration may set an initial calibration value for the cutting machine 200, and the second/home calibration may further refine and/or precisely dial-in the calibration settings of the cutting machine 200.

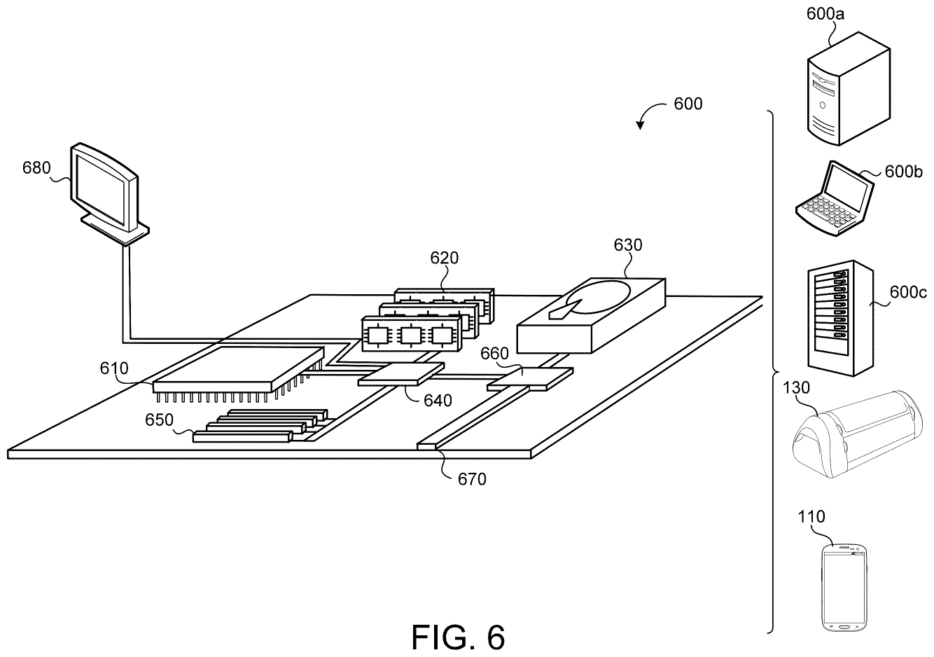

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610 (interchangeably referred to as “data processing hardware”), memory 620 (interchangeably referred to as “memory hardware”), a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 (e.g., the data processing hardware 112 of the user device 110 or the data processing hardware 212 of the cutting machine 200) can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 (e.g., memory hardware 114 of the user device 110 or the memory hardware 214 of the cutting machine 200) stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

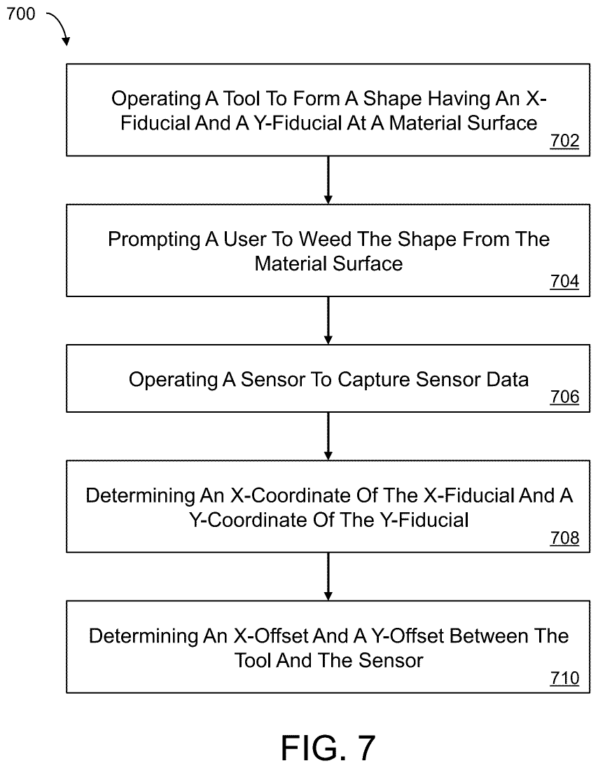

FIG. 7 provides a flowchart for an exemplary arrangement of operations for a method 700 of calibrating a tool 204 and a sensor 206 of a cutting machine 200. The method 700 may execute on data processing hardware 610 (FIG. 6) based on instructions stored on memory hardware 620 (FIG. 6) in communication with the data processing hardware 610. At operation 702, the method 700 includes operating the tool 204 of the cutting machine 200 to form a shape 304 at a material surface 302. Here, the shape includes an x-fiducial 306 at an estimated x-coordinate 310 at the material surface 302 and a y-fiducial 308 at an estimated y-coordinate 314 at the material surface 302.

At operation 704, the method 700 includes prompting a user 10 to weed the shape from the material surface 302, and at operation 706, the method 700 includes operating the sensor 206 of the cutting machine 200 to capture sensor data representative of the material surface 302 with the shape 304 weeded from the material surface 302.

At operation 708, the method 700 includes determining, based on the captured sensor data, a measured x-coordinate 312 of the x-fiducial 306 at the material surface 302 and a measured y-coordinate 316 of the y-fiducial 308 at the material surface 302. At operation 710, the method 700 includes determining an x-offset and a y-offset between the tool 204 and the sensor 206 of the cutting machine 200 based on a comparison of the estimated x-coordinate 310 and the measured x-coordinate 312 of the x-fiducial 306 and a comparison of the estimated y-coordinate 314 and the measured y-coordinate 316 of the y-fiducial 308.

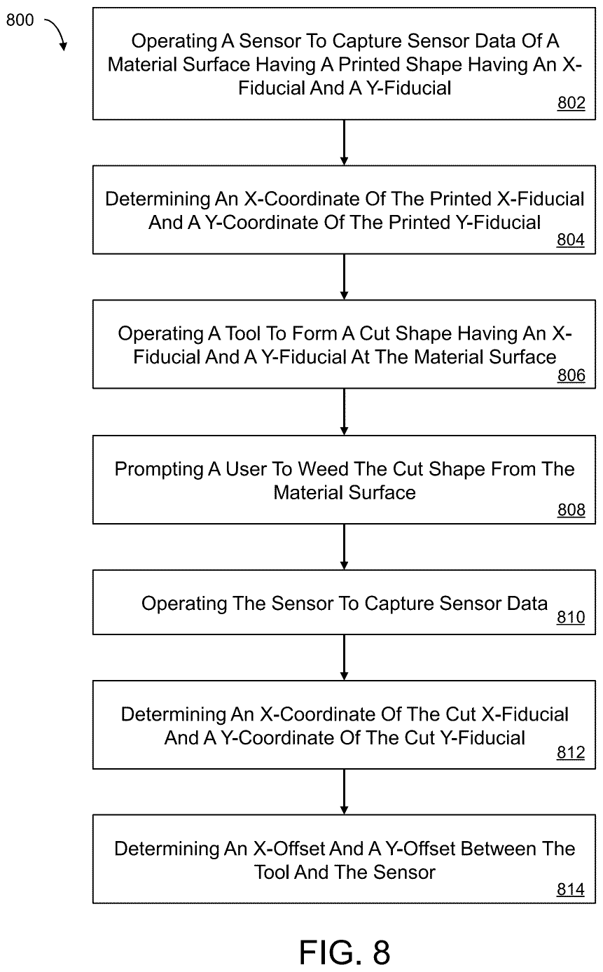

FIG. 8 provides a flowchart of an exemplary arrangement of operations for a method 800 of calibrating a tool 204 and a sensor 206 of a cutting machine 200. The method 800 may execute on data processing hardware 610 (FIG. 6) based on instructions stored on memory hardware 620 (FIG. 6) in communication with the data processing hardware 610. At operation 802, the method 800 includes operating the sensor 206 of the cutting machine 200 to capture a first set of sensor data representative of a material surface 302. The material surface includes a printed shape 318, and the printed shape includes a printed x-fiducial 320 and a printed y-fiducial 322.

At operation 804, the method 800 includes determining, based on the first set of sensor data, a printed x-coordinate 324 of the printed x-fiducial 320 at the material surface 302 and a printed y-coordinate 326 of the printed y-fiducial 322 at the material surface 302, and at operation 806, the method 800 includes operating the tool 204 of the cutting machine 200 to form a cut shape 304 at the material surface 302. The cut shape 304 includes a cut x-fiducial 306 and a cut y-fiducial 308.

At operation 808, the method 800 includes prompting a user 10 to weed the cut shape 304 from the material surface 302, and with the cut shape 304 weeded from the material surface 302, the method 800 also includes operating the sensor 206 of the cutting machine 200 to capture a second set of sensor data representative of the material surface 302 at operation 810. At operation 812, the method 800 includes determining, based on the second set of sensor data, a measured x-coordinate 312 of the cut x-fiducial 306 at the material surface 302 and a measured y-coordinate 316 of the cut y-fiducial 308 at the material surface 302. At operation 814, the method 800 also includes determining, based on a comparison of the measured x-coordinate 312 of the cut x-fiducial 306 and the printed x-coordinate 324 of the printed x-fiducial 320 and a comparison of the measured y-coordinate 316 of the cut y-fiducial 308 and the printed y-coordinate 326 of the printed y-fiducial 322, an x-offset and a y-offset between the tool 204 and the sensor 206 of the cutting machine 200.

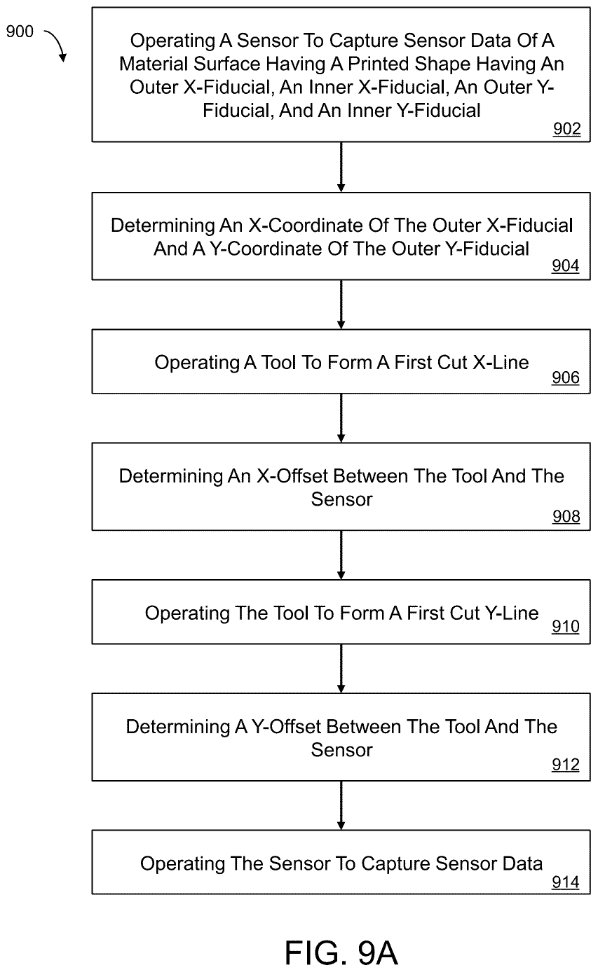

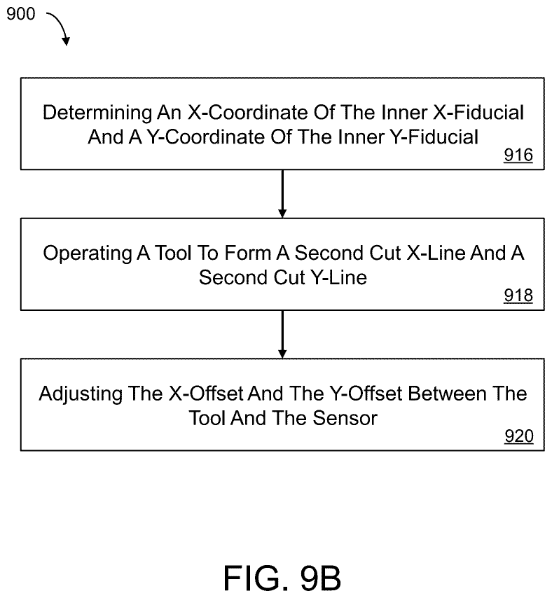

FIGS. 9A and 9B provide a flowchart of an exemplary arrangement of operations for a method 900 of calibrating a tool 204 and a sensor 206 of a cutting machine 200. The method 900 may execute on data processing hardware 610 (FIG. 6) based on instructions stored on memory hardware 620 (FIG. 6) in communication with the data processing hardware 610. At operation 902, the method 900 includes operating the sensor 206 of the cutting machine 200 to capture a first set of sensor data representative of a material surface 302. The material surface 302 includes a printed shape 318, and the printed shape 318 includes an outer x-fiducial 320, an outer y-fiducial 322, an inner x-fiducial 321, and an inner y-fiducial 323.

At operation 904, the method 900 includes determining, based on the first set of sensor data, a printed x-coordinate 324 of the outer x-fiducial 320 at the material surface 302 and a printed y-coordinate 326 of the outer y-fiducial 322 at the material surface 302, and at operation 906, the method 900 includes operating the tool 204 of the cutting machine 200 to form a first cut x-line 306 at the material surface 302. The first cut x-line 306 has a first cut x-coordinate 312.

At operation 908, the method 900 also includes determining, based on a comparison of the first cut x-coordinate 312 of the first cut x-line 306 and the printed x-coordinate 324 of the outer x-fiducial 320, an x-offset between the tool 204 and the sensor 206 of the cutting machine 200, and at operation 910, the method 900 includes operating the tool 204 of the cutting machine 200 to form a first cut y-line 308 at the material surface 302. The first cut y-line 308 has a first cut y-coordinate 316.

At operation 912, the method 900 also includes determining, based on a comparison of the first cut y-coordinate 316 of the first cut y-line 308 and the printed y-coordinate 326 of the outer y-fiducial 322, a y-offset between the tool 204 and the sensor 206 of the cutting machine 200, and at operation 914, the method 900 includes operating the sensor 206 of the cutting machine 200 to capture a second set of sensor data representative of the material surface 302.

At operation 916, the method 900 includes determining, based on the second set of sensor data, a printed x-coordinate 325 of the inner x-fiducial 321 at the material surface 302 and a printed y-coordinate 327 of the inner y-fiducial 323 at the material surface 302, and based on the determined x-offset and the determined y-offset, the method 900 also includes operating the tool 204 of the cutting machine to form a second cut x-line 307 and a second cut y-line 309 at the material surface 302 at operation 918. Here, the second cut x-line 307 has a second cut x-coordinate 313 and the second cut y-line 309 has a second cut y-coordinate 317. At operation 920, the method 900 also includes adjusting, based on a comparison of the second cut x-coordinate 313 of the second cut x-line 309 and the printed x-coordinate 325 of the inner x-fiducial 321 and a comparison of the second cut y-coordinate 317 of the second cut y-line 309 and the printed y-coordinate 327 of the inner y-fiducial 323, the x-offset and the y-offset between the tool 204 and the sensor 206 of the cutting machine 200.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Reference throughout this specification to features, advantages, or similar language does not imply that all of the features and advantages that may be realized with the present disclosure should be or are in any single embodiment of the invention.

Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. No claim element is intended to invoke 35 U.S.C. 112(f) unless the element is expressly recited using the phrase “means for.”

The scope of the disclosure is to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. Further, the term “plurality” can be defined as “at least two.” As used herein, the phrase “at least one of”, when used with a list of items, means different combinations of one or more of the listed items may be used and only one of the items in the list may be needed. The item may be a particular object, thing, or category. Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A, B, and C. In some cases, “at least one of item A, item B, and item C” may mean, for example, without limitation, two of item A, one of item B, and ten of item C; four of item B and seven of item C; or some other suitable combination.

All ranges and ratio limits disclosed herein may be combined. Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one or more embodiments of the presented method. The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. Other steps and methods may be conceived that are equivalent in function, logic, or effect to one or more steps, or portions thereof, of the illustrated method.

Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Furthermore, no element, component, or method step in the present disclosure is intended to be dedicated to the public regardless of whether the element, component, or method step is explicitly recited in the claims.

The subject matter of the present disclosure may be embodied in other specific forms without departing from its spirit or essential characteristics. The described embodiments are to be considered in all respects only as illustrative and not restrictive.

The scope of the disclosure is, therefore, indicated by the appended claims rather than by the foregoing description. All changes which come within the meaning and range of equivalency of the claims are to be embraced within their scope.

What is claimed is:

1. A computer-implemented method when executed on data processing hardware causes the data processing hardware to perform operations comprising:
operating a sensor of a cutting machine to capture a first set of sensor data representative of a material surface, the material surface having a printed shape, and the printed shape having a printed x-fiducial and a printed y-fiducial;
based on the first set of sensor data, determining a printed x-coordinate of the printed x-fiducial at the material surface and a printed y-coordinate of the printed y-fiducial at the material surface;
operating a tool of the cutting machine to form a cut shape at the material surface, the cut shape having a cut x-fiducial and a cut y-fiducial;
prompting a user to weed the cut shape from the material surface;
with the cut shape weeded from the material surface, operating the sensor of the cutting machine to capture a second set of sensor data representative of the material surface;
based on the second set of sensor data, determining a measured x-coordinate of the cut x-fiducial at the material surface and a measured y-coordinate of the cut y-fiducial at the material surface; and
based on a comparison of the measured x-coordinate of the cut x-fiducial and the printed x-coordinate of the printed x-fiducial and a comparison of the measured y-coordinate of the cut y-fiducial and the printed y-coordinate of the printed y-fiducial, determining an x-offset and a y-offset between the tool and the sensor of the cutting machine.

2. The method of claim 1, wherein the cut shape is formed at the material surface within a boundary of the printed shape.

3. The method of claim 1, wherein the operations further comprise prompting the user to initiate a calibration sequence.

4. The method of claim 3, wherein the operations further comprise, responsive to the user initiating the calibration sequence, prompting the user to load the material surface at the cutting machine.

5. The method of claim 1, wherein:
the printed x-fiducial comprises a first printed x-fiducial having a first printed x-coordinate at the material surface and a second printed x-fiducial having a second printed x-coordinate at the material surface, the second printed x-coordinate spaced from the first printed x-coordinate at the material surface;
the cut x-fiducial comprises a first cut x-fiducial having a first measured x-coordinate at the material surface and a second cut x-fiducial having a second measured x-coordinate at the material surface, the second measured x-coordinate spaced from the first measured x-coordinate at the material surface; and
determining the x-offset between the tool and the sensor of the cutting machine is based on a comparison of the first measured x-coordinate of the first cut x-fiducial and the first printed x-coordinate of the first printed x-fiducial and a comparison of the second measured x-coordinate of the second cut x-fiducial and the second printed x-coordinate of the second printed x-fiducial.

6. The method of claim 5, wherein operating the tool of the cutting machine to form the cut shape at the material surface comprises attempting to form the cut shape so that a distance at the material surface between the first measured x-coordinate of the first cut x-fiducial and the first printed x-coordinate of the first printed x-fiducial is equal to a distance at the material surface between the second measured x-coordinate of the second cut x-fiducial and the second printed x-coordinate of the second printed x-fiducial.

7. The method of claim 1, wherein:
the printed y-fiducial comprises a first printed y-fiducial having a first printed y-coordinate at the material surface and a second printed y-fiducial having a second printed y-coordinate at the material surface, the second printed y-coordinate spaced from the first printed y-coordinate at the material surface;
the cut y-fiducial comprises a first cut y-fiducial having a first measured y-coordinate at the material surface and a second cut y-fiducial having a second measured y-coordinate at the material surface, the second measured y-coordinate spaced from the first measured y-coordinate at the material surface; and
determining the y-offset between the tool and the sensor of the cutting machine is based on a comparison of the first measured y-coordinate of the first cut y-fiducial and the first printed y-coordinate of the first printed y-fiducial and a comparison of the second measured y-coordinate of the second cut y-fiducial and the second printed y-coordinate of the second printed x-fiducial.

8. The method of claim 7, wherein operating the tool of the cutting machine to form the cut shape at the material surface comprises attempting to form the cut shape so that a distance at the material surface between the first measured y-coordinate of the first cut y-fiducial and the first printed y-coordinate of the first printed y-fiducial is equal to a distance at the material surface between the second measured y-coordinate of the second cut y-fiducial and the second printed y-coordinate of the second printed y-fiducial.

9. The method of claim 1, wherein the cut shape is weeded from the material surface without removing the material surface from the cutting machine.

10. The method of claim 1, wherein operating the sensor of the cutting machine to capture the second set of sensor data is responsive to a user input to resume a calibration sequence.

11. The method of claim 1, wherein the material surface comprises a sheet of paper.

12. A system comprising:
data processing hardware; and
memory hardware in communication with the data processing hardware and storing instructions that when executed on the data processing hardware causes the data processing hardware to perform operations comprising:
operating a sensor of a cutting machine to capture a first set of sensor data representative of a material surface, the material surface having a printed shape, and the printed shape having a printed x-fiducial and a printed y-fiducial;
based on the first set of sensor data, determining a printed x-coordinate of the printed x-fiducial at the material surface and a printed y-coordinate of the printed y-fiducial at the material surface;
operating a tool of the cutting machine to form a cut shape at the material surface, the cut shape having a cut x-fiducial and a cut y-fiducial;
prompting a user to weed the cut shape from the material surface;
with the cut shape weeded from the material surface, operating the sensor of the cutting machine to capture a second set of sensor data representative of the material surface;
based on the second set of sensor data, determining a measured x-coordinate of the cut x-fiducial at the material surface and a measured y-coordinate of the cut y-fiducial at the material surface; and
based on a comparison of the measured x-coordinate of the cut x-fiducial and the printed x-coordinate of the printed x-fiducial and a comparison of the measured y-coordinate of the cut y-fiducial and the printed y-coordinate of the printed y-fiducial, determining an x-offset and a y-offset between the tool and the sensor of the cutting machine.

13. The system of claim 12, wherein the cut shape is formed at the material surface within a boundary of the printed shape.

14. The system of claim 12, wherein the operations further comprise prompting the user to initiate a calibration sequence.

15. The system of claim 14, wherein the operations further comprise, responsive to the user initiating the calibration sequence, prompting the user to load the material surface at the cutting machine.

16. The system of claim 12, wherein:
the printed x-fiducial comprises a first printed x-fiducial having a first printed x-coordinate at the material surface and a second printed x-fiducial having a second printed x-coordinate at the material surface, the second printed x-coordinate spaced from the first printed x-coordinate at the material surface;
the cut x-fiducial comprises a first cut x-fiducial having a first measured x-coordinate at the material surface and a second cut x-fiducial having a second measured x-coordinate at the material surface, the second measured x-coordinate spaced from the first measured x-coordinate at the material surface; and
determining the x-offset between the tool and the sensor of the cutting machine is based on a comparison of the first measured x-coordinate of the first cut x-fiducial and the first printed x-coordinate of the first printed x-fiducial and a comparison of the second measured x-coordinate of the second cut x-fiducial and the second printed x-coordinate of the second printed x-fiducial.

17. The system of claim 16, wherein operating the tool of the cutting machine to form the cut shape at the material surface comprises attempting to form the cut shape so that a distance at the material surface between the first measured x-coordinate of the first cut x-fiducial and the first printed x-coordinate of the first printed x-fiducial is equal to a distance at the material surface between the second measured x-coordinate of the second cut x-fiducial and the second printed x-coordinate of the second printed x-fiducial.

18. The system of claim 16, wherein:
the printed y-fiducial comprises a first printed y-fiducial having a first printed y-coordinate at the material surface and a second printed y-fiducial having a second printed y-coordinate at the material surface, the second printed y-coordinate spaced from the first printed y-coordinate at the material surface;
the cut y-fiducial comprises a first cut y-fiducial having a first measured y-coordinate at the material surface and a second cut y-fiducial having a second measured y-coordinate at the material surface, the second measured y-coordinate spaced from the first measured y-coordinate at the material surface; and
determining the y-offset between the tool and the sensor of the cutting machine is based on a comparison of the first measured y-coordinate of the first cut y-fiducial and the first printed y-coordinate of the first printed y-fiducial and a comparison of the second measured y-coordinate of the second cut y-fiducial and the second printed y-coordinate of the second printed x-fiducial.

19. The system of claim 18, wherein operating the tool of the cutting machine to form the cut shape at the material surface comprises attempting to form the cut shape so that a distance at the material surface between the first measured y-coordinate of the first cut y-fiducial and the first printed y-coordinate of the first printed y-fiducial is equal to a distance at the material surface between the second measured y-coordinate of the second cut y-fiducial and the second printed y-coordinate of the second printed y-fiducial.

20. The system of claim 12, wherein the cut shape is weeded from the material surface without removing the material surface from the cutting machine.

21. The system of claim 12, wherein operating the sensor of the cutting machine to capture the second set of sensor data is responsive to a user input to resume a calibration sequence.

22. The system of claim 12, wherein the material surface comprises a sheet of paper.
